(19) United States
(12) Patent Application Publication
(10) Pub. No.: US 2015/0301623 A1
(43) Pub. Date: Oct. 22, 2015

(54) INPUT DEVICES AND INPUT METHODS

(71) Applicant: Deyuan WANG, (US)

(72) Inventor: Deyuan WANG, BEIJING (CN)

(73) Assignee: Deyuan WANG, BEIJING (CN)

(21) Appl. No.: 14/653,425

(22) PCT Filed: Dec. 21, 2012
(86) PCT No.: PCT/CN2012/087163

§ 371 Date: Jun. 18, 2015

(51) Int. Cl. G06F 3/03

(52) U.S. Cl. CPC G06F 3/0317

(57) ABSTRACT

An input device and an input method are provided. An example input device may include a projection module configured to project an image. The projection module is configured to be movable to cause a variation in the projected image. The variation indicates direction information about the movement to control movement of a controlled target.

### TECHNICAL FIELD

The present disclosure generally relates to input devices, and in particular, to input devices and methods for inputting direction information.

### BACKGROUND

Windows™ is generally used in existing computer systems. In operating Windows™, a mouse is usually used in order to control a cursor on a display screen. The mouse is generally a device which is slidable on a plane. The device, when sliding, detects direction information according to a sliding direction thereof on the plane, and transmits the information to a computer system to control the cursor on the display to move accordingly.

Currently, optical detection methods are widely used. Specifically, an optical irradiation device and a reflection receiving device are installed on the bottom of the sliding device. When the sliding device slides, light emitted from the optical irradiation device to the sliding plane is partly reflected by the sliding plane, and a part of the reflected light is received by the reflection receiving device. The reflected light comprises movement information. The reflected light is processed to obtain sliding direction information, and the information is transmitted to the computer system to control the movement of the cursor.

However, those methods have a disadvantage. Specifically, there must be a particular plane on which the sliding device can slide. Therefore, the use of such methods is limited by the environment.

### SUMMARY

In view of the above problems, the present disclosure provides an input device and an input method, by which it is possible to input direction information more conveniently to, for example, control movement of a target (for example, a cursor on a display or the like).

Other solutions of the present disclosure in part are set forth in the description below, and in part will be clear through the description or can be known by practice of the present disclosure.

According to an aspect of the present disclosure, there is provided an input device, comprising a projection module configured to project an image. The projection module is configured to be movable to cause a variation in the projected image. The variation indicates direction information about the movement, which may be used for controlling movement of a controlled target.

According to an embodiment, the input device may further comprise an image capture module configured to capture at least a part of the projected image. The image capture module may be configured to be fixed so that when the projection module is moved, there is a variation in the captured image which indicates the direction information.

According to an embodiment, the input device may further comprise a direction information determination module configured to determine the direction information according to the variation. Alternatively, according to another embodiment, the direction information determination module may be provided in a host device for which the input device is used.

According to an embodiment, the image capture module may comprise an array of imaging pixels, for use in high definition imaging. Alternatively, according to another embodiment, the image capture module may comprise a number of discrete imaging pixel points, for use in coarse imaging.

According to an embodiment, the projected image may comprise at least one of: an array of straight lines which intersect in orthogonal directions, a two-dimensional lattice, an array of special unit patterns (for example, the same unit patterns), or other regular or irregular patterns.

According to another embodiment, the projection module is configured to project two images. The two projected images may be overlapped on a projection plane. Accordingly, the projection module may comprise two projection sub-modules for projecting the two images, respectively.

According to another embodiment, the input device may further comprise an image capture module configured to capture at least a part of each of the two projected images. For example, the projection module may be configured to project the two images with radiation in different polarization states, and the image capture module may comprise a polarization separator to separate the projected images. Alternatively, the projection module may be configured to project the two images with radiation at different wavelengths, and the image capture module may comprise a wavelength separator to separate the projected images. Alternatively, the projection module may be configured to project the two images with radiation whose intensity is modulated at different frequencies, and the image capture module may comprise demodulators at corresponding frequencies to separate the projected images. Alternatively, the projection module may be configured to project the two images in a time division manner, and the image capture module may be configured to separate the projected images in a corresponding time division manner.

Thus, the image capture module may separate the projected images which are possibly overlapped, and then capture at least a part of each of the images. When the projection module is moved, the two projected images (or parts thereof) which are separated by the image capture module also vary. Among them, a variation in one of the captured images may indicate direction information about movement in a first direction (for example, from left to right), and a variation in the other of the captured images may indicate direction information about movement in a second direction (for example, from up to down) orthogonal to the first direction. A vector sum of the variations in the two images may indicate the direction information about movement of the projection module.

According to another embodiment, one of the two images projected by the projection module may be configured so that radiation thereof has a luminance monotonously increasing along a first direction (for example, from down to up, or from up to down), and the other of the two images may be configured so that radiation thereof has a luminance monotonously increasing along a second direction orthogonal to the first direction (for example, from right to left, or from left to right).

According to another embodiment, one of the two images projected by the projection module may be configured so that radiation thereof has a wavelength monotonously increasing along a first direction (for example, from down to up, or from up to down), and the other of the two images may be configured so that radiation thereof has a wavelength monotonously increasing along a second direction orthogonal to the first direction (for example, from right to left, or from left to right).

According to another embodiment, one of the two images projected by the projection module may be configured so that radiation thereof has a chroma monotonously varying along a first direction (for example, from down to up, or from up to down), and the other of the two images may be configured so that radiation thereof has a chroma monotonously varying along a second direction orthogonal to the first direction (for example, from right to left, or from left to right).

According to another embodiment, the input device may further comprise a feedback control device configured to adjust the luminance of the images projected by the projection module when the projection module is moved, so that the luminance of the captured images remains substantially unvaried before and after the movement, wherein an adjusted amount of the luminance indicates the direction information.

According to another embodiment, the input device may further comprise a feedback control device configured to adjust the chroma of the images projected by the projection module when the projection module is moved, so that the chroma of the captured images remains substantially unvaried before and after the movement, wherein an adjusted amount of the chroma indicates the direction information.

According to another aspect of the present disclosure, there is provided an input method, comprising: projecting, by a projection module, an image; moving the projection module to cause a variation in the projected image; and determining direction information about the movement according to the variation to control movement of a controlled target.

According to an embodiment, the input method may further comprise capturing, by a capture module, at least a part of the projected image. In this case, determining direction information may comprise determining the direction information according to a variation in the captured image.

According to an embodiment, projecting an image may comprise projecting two images. The two images may be overlapped on a projection plane.

According to an embodiment, the input method may further comprise capturing, by the capture module, at least a part of each of the two projected images. For example, the projecting may comprise projecting the two images with radiation in different polarization states, and the capturing may comprise separating, by a polarization separator, the projected images. Alternatively, the projecting may comprise projecting the two images with radiation at different wavelengths, and the capturing may comprise separating, by a wavelength separator, the projected images. Alternatively, the projecting may comprise projecting the two images with radiation whose intensity is modulated at different frequencies, and the capturing may comprise separating, by demodulators at corresponding wavelengths, the projected images. Alternatively, the projecting may comprise projecting the two images in a time division manner, and the capturing may comprise separating the projected images in a corresponding time division manner.

According to an embodiment, one of the two projected images may be configured so that radiation thereof has a luminance monotonously increasing along a first direction, and the other of the two projected images may be configured so that radiation thereof has a luminance monotonously increasing along a second direction orthogonal to the first direction. In this case, the method may further comprise adjusting the luminance of the images projected by the projection module when the projection module is moved, so that the luminance of the captured images remains substantially unvaried before and after the movement, wherein an adjusted amount of the luminance indicates the direction information.

According to an embodiment, one of the two projected images may be configured so that radiation thereof has a wavelength monotonously increasing along a first direction, and the other of the two projected images may be configured so that radiation thereof has a wavelength monotonously increasing along a second direction orthogonal to the first direction.

According to an embodiment, one of the two projected images may be configured so that radiation thereof has a chroma monotonously varying along a first direction, and the other of the two projected images may be configured so that radiation thereof has a chroma monotonously varying along a second direction orthogonal to the first direction. In this case, the method may further comprise adjusting the chroma of the images projected by the projection module when the projection module is moved, so that the chroma of the captured images remains substantially unvaried before and after the movement, wherein an adjusted amount of the chroma indicates the direction information.

According to an embodiment of the present disclosure, the projection may be carried out through one or more of visible light, infrared light, ultraviolet light, or other rays.

### BRIEF DESCRIPTION OF THE DRAWINGS

The above and other features and advantages of embodiments of the present disclosure will become more apparent from the following description of the embodiments of the present disclosure with reference to the accompanying drawings, in which:

FIG. 1 is a schematic diagram illustrating a scenario where an input device is applied according to an embodiment of the present disclosure;

FIG. 2 is a schematic diagram illustrating a projected image of an input device according to an embodiment of the present disclosure;

FIG. 3 is a schematic diagram illustrating a projected image of an input device according to another embodiment of the present disclosure;

FIG. 4 is a schematic diagram illustrating a scenario where an input device is applied according to another embodiment of the present disclosure;

FIG. 5 is a schematic diagram illustrating a projected image of an input device according to another embodiment of the present disclosure; and

FIG. 6 is a block diagram illustrating an input device according to an embodiment of the present disclosure.

### DETAILED DESCRIPTION

Embodiments of the present disclose will be described in detail below, and examples thereof are illustrated in the accompanying drawings. It should be understood that the description is merely illustrative, and is not intended to limit the scope of the present disclosure.

There are a variety of projection devices to project static and/or dynamic images. For example, dynamic images may be projected optically by a film projector or a projection TV onto a screen, so that the images which are continuously varying can be viewed on the screen. In addition, a static image may be projected by, for example, a slide projector onto a screen.

According to embodiments of the present disclosure, a projection module may be incorporated into an input device, and configured to project an image. The projection module is movable, and thereby the projected image may vary. Such variation in the projected image may indicate direction information about the movement of the projection module. The direction information may be inputted into a host device to control movement of a controlled target. For example, the host device may comprise a computing device such as a computer, and the controlled target may comprise an indicator or a cursor on the computing device; or the host device may comprise a robot or a remote controlled toy or the like, and the controlled target may be the host device itself, or the like. In addition, the direction information may be used to control navigation, browsing or the like of menus, documents or the like displayed on an electronic device.

According to embodiments of the present disclosure, an image capture module may be further provided, and configured to capture at least a part of the projected image. The image capture module may be configured to be fixed, to easily determine the direction information about the movement of the projection module. Thereby, when the projection direction varies upward, downward, to the left or to the right in response to the movement of the projection module, the image captured by the image capture module may move upward, downward, to the left or to the right accordingly. The image capture module may be provided in the host device, for example.

According to embodiments of the present disclosure, a direction information determination module may be further provided, and configured to determine the direction information about the movement of the projection module according to the image captured by the image capture module. The direction information determination module may be provided in the host device, for example. According to a preferable embodiment, the direction information determination module may be implemented by a processing device in the host device, such as a microprocessor (μP) or a Central Processing Unit (CPU) or the like.

FIG. 6 is a block diagram illustrating an input device according to an embodiment of the present disclosure. As shown in FIG. 6, the input device according to the embodiment comprises a projection module 601. The projection module 601 is configured to project an image, preferably, a static image. For example, the projected image may have features arranged along two orthogonal directions on an image plane, so as to conveniently indicate the direction information in the two orthogonal directions. Of course, the projected image is not limited thereto. The projection module 601 may be implemented in various manners.

The input device may further comprise an image capture module 604. The image capture module 604 may be arranged opposite to the projection module 601, and is in the field of view of the projection module 601, so as to capture at least a part of the image projected by the projection module 601. Specifically, the image capture module 604 may comprise an imaging module 606. The projection module 601 and the imaging module 606 may have a distance therebetween and their respective optical systems arranged so that the imaging module 606 can acquire a relatively clear image. Preferably, the relative distance between the projection module 601 and the imaging module 606 may vary in a certain range, without substantially influencing the imaging quality of the imaging module 606.

In addition, the image capture module 604 may further comprise a direction information determination module 608. The direction information determination module 608 is configured to determine the direction information about the movement of the projection module 601 according to the projected image (or a part thereof) acquired by the imaging module 606. The direction information determination module 608 may comprise an interface to the host device (not shown), to transmit the determined direction information to the host device. For example, the interface may comprise a wired interface such as a Universal Serial Bus (USB) interface, and/or a wireless interface such as a Bluetooth interface.

Although in the example of FIG. 6, the direction information determination module 608 is illustrated as being included in the image capture module 604, the present disclosure is not limited thereto. For example, the direction information determination module 608 may be arranged separately from the image capture module 604. The direction information determination module 608 may be a part of the host device, for example, a processing device of the host device. In this case, the image capture module 604 (or the imaging module 606 therein) may have an interface to the host device, to transmit the acquired image information to the host device for use by the direction information determination module in the host device to determine the direction information. This interface may also comprise a suitable wired and/or wireless interface.

In addition, although in the example of FIG. 6, the image capture module 604 (particularly, the imaging module 606 therein) is illustrated as a separate module, the present disclosure is not limited thereto. For example, the imaging module 606 may be implemented as a part of the host device. The host device, for example, a computing device or a mobile terminal, may have an imaging device such as a camera integrated therein. The imaging module 606 may be implemented by the imaging device. In this case, a driving program for the imaging device may be updated in the host device, or a new driving program may be loaded to the host device. The functionality of the direction information determination module may be implemented by the host device (or the processing device thereof) executing the updated or downloaded driving program. According to the present disclosure, particularly the description of the direction information determination module, development of the driving program is within the capability of those skilled in the art.

Therefore, the input device according to the present disclosure may be provided in various forms. For example, the input device may be provided by a kit of the projection module 601 and the image capture module 604. The user may buy the kit and connect the kit to his or her host device to implement input of direction information. Alternatively, the input device may be provided by a kit of the projection module 601 and the imaging module 606. The user may buy the kit, fix the imaging module 606 to the host device and connect the imaging module 606 to the host device via the interface to implement input of direction information. Alternatively, the input device may be provided by the projection module 601. In this case, the user only needs to buy the projection module 601, install the projection module 601 opposite to the imaging device of the host device such as a camera, and adjust the projection module 601 to enable the imaging device to capture the image projected by the projection module 601. In the latter two cases, the user may buy a driving program provided by a provider in a form of, for example, an information storage medium (for example, an optical disc) or download the driving program from a website of the provider over network and then execute the driving program on his or her host device, to implement the functionality of the direction information determination module.

In addition to the above input device, an input method according to an embodiment of the present disclosure is further provided. The input method may comprise: projecting, by a projection module, an image; moving the projection module to cause a variation in the projected image; and determining direction information about the movement according to the variation to control movement of a controlled target.

The technology of the present disclosure may be implemented in various ways, and some examples thereof will be described below.

### First Embodiment

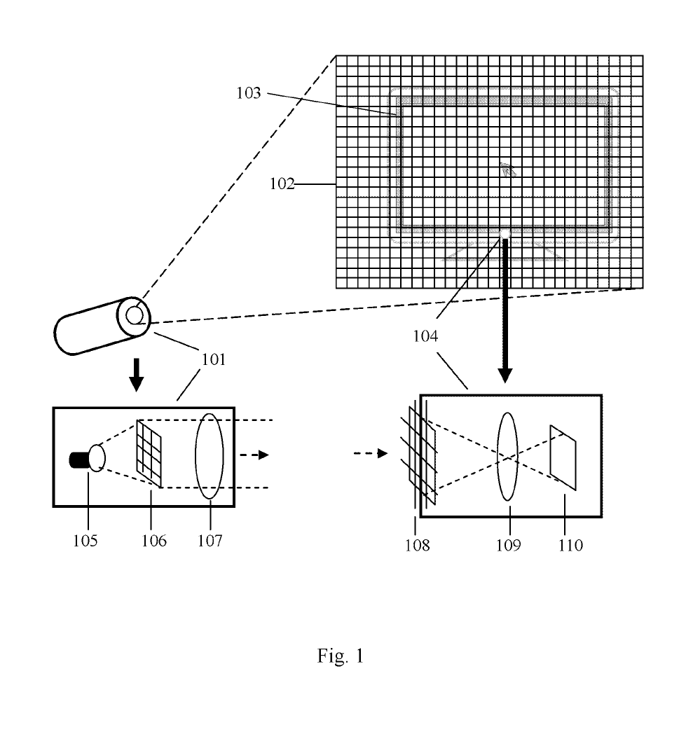

FIG. 1 is a schematic diagram illustrating a scenario where an input device in applied according to an embodiment of the present disclosure. The input device according to the embodiment may comprise a projection module 101. A static image 106 is projected from the projection module 101. Here, it is assumed that the image 106 is projected to a hypothetical projection plane 102 (that is, the projected image achieves an optimal definition on the projection plane 102). The projection plane 102 may be not far from the projection module 101. An image capture module 104 is arranged at a position where the projected image on the projection plane 102 can be imaged, and the image capture module 104 is kept within the projection range of the protection plane 102. In this way, the image captured by the image capture module 104 is at least a part of the projected image on the projection plane 102. Here, the projection module 101 and/or the image capture module 104 may have a depth of field, so that even if a distance between the projection module 101 and the image capture module 104 along the projection direction varies in a certain range, the image capture module 104 can capture a relatively clear image.

The projection module 101 may comprise an irradiation source 105. The irradiation source 105 may emit various suitable radiation. For example, the irradiation source 105 may comprise a visible light source, such as a Light Emitting Diode (LED) source or an array of LEDs, to emit visible light, or a ray source such as an Infrared (IR) source or an Ultraviolet (UV) source, to emit ray such as infrared light, ultraviolet light or the like. That is, the projection module 101 may implement projection using various suitable radiation, such as visible light, infrared light, ultraviolet light, or the like. Here, the irradiation source 105 may be configured as a point irradiation source or a planar irradiation source.

The projection module 101 may also comprise an image generation device 106. For example, the image generation device 106 may comprise an image mask similar to a slide, to generate a fixed image to be projected. Alternatively, the image generation device 106 may comprise a Spatial Light Modulator (SLM), such as a liquid crystal SLM, to generate different images as required to be projected. The radiation from the irradiation source 105 passes through the image generation device 106 and then carries a certain image thereon (for example, a part thereof is blocked by the image generation device 106 while another part thereof is transmitted).

The projection module 101 may further comprise an optical system 107. The radiation carrying the image may pass through the optical system 107, and then project onto the projection plane 102. Preferably, the optical system 107 is configured to be adjustable, to suitably adjust the position of the projection plane 102 and the size of the projection range of the projection module 101.

The image capture module 104 may comprise an imaging module, which may comprise an optical system 109 and an imaging plane 110. The imaging plane 110 may comprise a photoelectric converter to convert an optical signal of the projected image 108 (or a part thereof) acquired by the optical system 109 from the projection module 101 into an electrical signal. The electrical signal may then be transmitted to a direction information determination module (not shown). Here, the optical system 107 of the projection module 101 and the optical system 109 of the image capture module 104 may be adjusted so that the imaging device can capture a relatively clear image.

According to some embodiments of the present disclosure, the imaging plane 110 may comprise an array of imaging pixels, for example, an array of Charge Coupled Devices (CCDs) or the like, to enable high definition imaging, thereby acquiring a clear version of the image 108. Alternatively, according to other embodiments of the present disclosure, the imaging plane 110 may comprise a number of discrete imaging pixel points for coarse imaging of the image 108, provided that the direction information can be determined from the image. For example, the imaging plane 110 may only comprise a number of photodiodes.

In the example illustrated in FIG. 1, the image capture module 104 is arranged on a display 103 of the host device. In this case, in order to avoid interference to contents displayed on the display 103, the projection module 101 may implement projection using invisible light, such as infrared light, ultraviolet light, or the like. Of course, the present disclosure is not limited thereto. For example, the image capture module 104 may be arranged separately from the host device.

In the example illustrated in FIG. 1, the projection image generated by the image generation device 106 comprises parallel straight lines arranged respectively along a first direction (the horizontal direction in this figure) and a second direction (the vertical direction in this figure) which are orthogonal to each other. These parallel lines cross each other to form a grid. This grid pattern is beneficial for determination of the direction information by the direction information determination module (not shown).

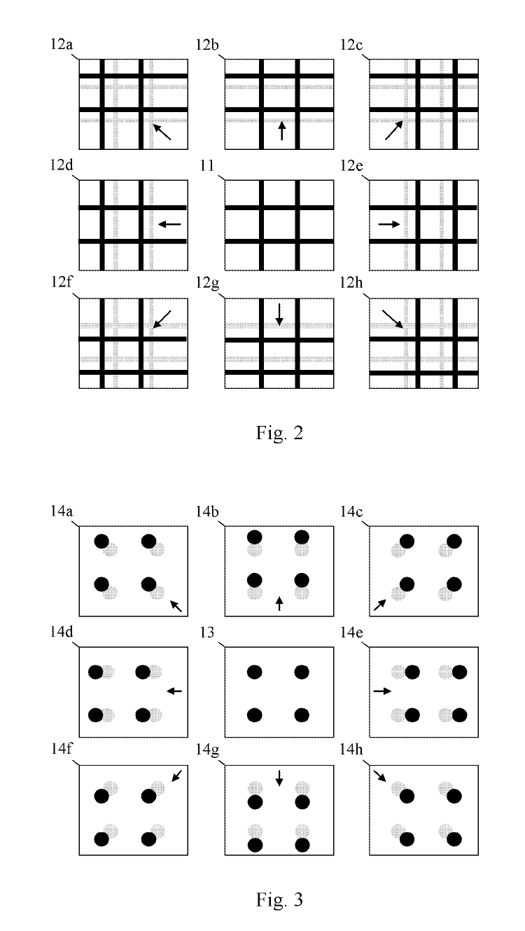

FIG. 2 illustrates an example in which the image captured by the image capture module is moved when the projection module 101 varies the projection direction. Specifically, image 11 in FIG. 2 shows a situation before the projection module 101 varies the projection direction, and images 12a, 12b, 12c, 12d, 12e, 12f, 12g, and 12h show situations after the projection module 101 is moved to the upper left, upward, to the upper right, to the left, to the right, to the lower left, downward, and to the lower right, respectively.

According to another example, the projection image generated by the image generation device 106 may comprise a two-dimensional lattice. FIG. 3 illustrates an example in this case, in which the image captured by the image capture module 104 is moved when the projection module 101 varies the projection direction. Specifically, image 13 in FIG. 3 shows a situation before the projection module 101 varies the projection direction, and images 14a, 14b, 14c, 14d, 14e, 14f, 14g, and 14h show situations after the projection module 101 is moved to the upper left, upward, to the upper right, to the left, to the right, to the lower left, downward, and to the lower right, respectively.

Of course, the projection image generated by the image generation device 106 is not limited to the above examples, and may be a variety of other suitable images, provided that images before and after the projection module 101 varies the projection direction can be recognized from the images obtained by the image capture module 104. For example, the projection image may comprise a (two-dimensional) array of particular unit patterns or other regular or irregular patterns. Of course, the projection image is not limited to the above two-dimensional array of lines or points or the like, and may also comprise a one-dimensional array. For example, in some applications, only one-dimensional direction information may suffice.

In the above examples, the projection image is set as a (one-dimensional or two-dimensional) array so that the image capture module 104 can easily capture (at least a part of) the projected image. In some cases, for example, if the projection module 101 has a relatively small projection range and the image capture module 104 has a relatively large imaging range so that the image capture module 104 can capture a majority of the projected image or even the whole projected image, there is no need to set such an array. In this case, the projection image illustrated in FIG. 2 may be set as a cross formed by a line along the first direction intersecting a further line along the second direction, and the projection image illustrated in FIG. 3 may be set even as a single point, for example.

Although FIGS. 2 and 3 merely illustrate situations of movement of the projection module 101 to the upper left, upward, the upper right, to the left, to the right, to the lower left, downward, to the lower right, those skilled in the art should understand that the projection module 101 may vary the projection in any direction. Accordingly, the image capture module 104 acquires the captured image which is varied in a corresponding direction. Thereby, the direction information determination module (not shown) may determine the direction information about the movement of the projection module 101 according to the variation in the captured image before and after the projection module 101 is moved.

### Second Embodiment

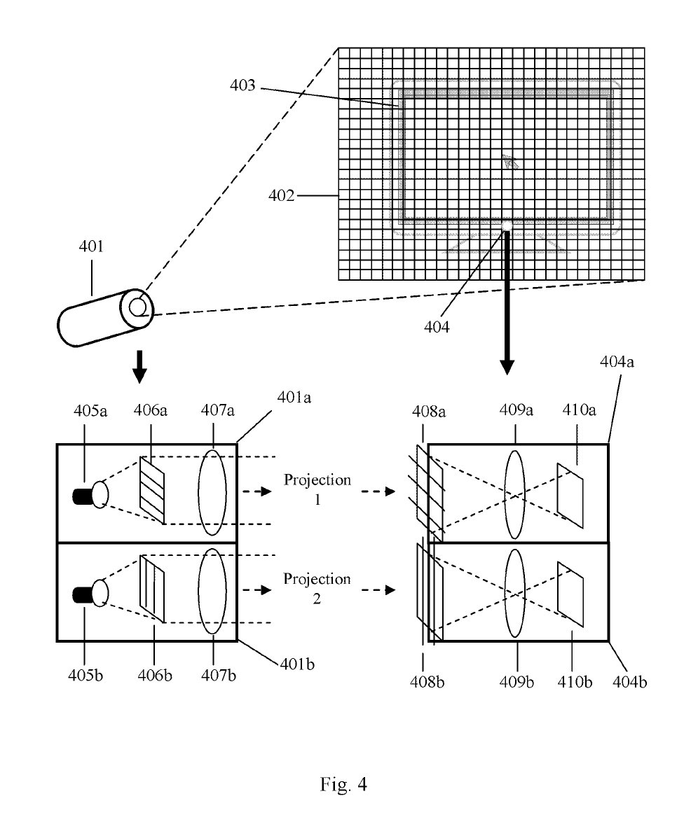

FIG. 4 is a schematic diagram illustrating a scenario where an input device is applied according to another embodiment of the present disclosure. The following description is mainly directed to differences between the second embodiment and the first embodiment.

As shown in FIG. 4, the input device according to the present embodiment may comprise a projection module 401. The projection module 401 may comprise two projection sub-modules 401a and 401b. Each of the projection sub-modules 401a and 401b may be configured as the projection module 101 in the above first embodiment. For example, the projection sub-module 401a may comprise an irradiation source 405a, an image generation device 406a and an optical system 407a; and the projection sub-module 401b may comprise an irradiation source 405b, an image generation device 406b and an optical system 407b. Thus, the projection module 401 may generate two different projections (through the projection sub-modules 401a and 401b), so that the two projections are overlapped on a projection plane 402. There may be no particular alignment relationship between the two projections, i.e., the two projections may be overlapped on the projection plane 402 in any suitable manner. Alternatively, the respective optical systems 407a and 407b of the projection sub-modules 401a and 401b may be adjusted so that the two projections are partly or completely overlapped on the projection plane 402. The respective projections of the projection sub-modules 401a and 401b may also be separated, or even located on different projection planes.

Alternatively, the projection module 401 may comprise a light combination device to combine projection light from the projection sub-modules 401a and 401b together and cast the combined light to project a combined image (the image generated by the image generation device 406a+the image generated by the image generation device 406b) onto the projection plane 402. There are various such light combination devices in the projector field.

It is to be noted that although the projection sub-modules 401a and 401b are illustrated as separated modules in FIG. 4, they may share some common part. For example, they may share a common irradiation source, from which radiation is emitted and then passes through, for example, a beam splitter to be used by the respective projection sub-modules. As another example, they may share a common optical system, through which radiation from the respective projection sub-modules, after passing through a beam combiner, is projected.

Accordingly, the image capture module 404 may also comprise two image capture sub-modules 404a and 404b, to capture the different projections from the projection sub-modules 401a and 401b, respectively. Each of the image capture sub-modules 404a and 404b may be configured as the image capture module 104 in the above first embodiment. For example, the image capture sub-module 404a may comprise an optical system 409a and an imaging plane 410a. The imaging plane 410a is configured to convert an optical signal of a projected image 408a (or a part thereof) acquired by the optical system 409a from the projection sub-module 401a into an electrical signal. The image capture sub-module 404b may comprise an optical system 409b and an imaging plane 410b. The imaging plane 410b is configured to convert an optical signal of a projected image 408b (or a part thereof) acquired by the optical system 409b from the projection sub-module 401b into an electrical signal. In the example illustrated in FIG. 4, the image capture module 404 may also be arranged on a display 403 of a host device (not shown).

For example, the image generation device 406a may be configured to generate features such as parallel lines arranged along a first direction (the horizontal direction in the figure), and the image generation device 406b may be configured to generate features such as parallel lines arranged along a second direction (the vertical direction in the figure), or vice versa. Of course, other projection patterns described in the first embodiment are also suitable for the present embodiment.

The image projected by the projection module 401 is not limited to a specific picture formed by interweaving of light and shade and/or color variation, or the like. According to other embodiments of the present disclosure, the projected image may comprise a pattern of monotonous variation in a feature, such as intensity (or luminance), wavelength, chroma, or the like, of the radiation for projection itself (for example, visible light, infrared light, ultraviolet light, or the like) along one or more directions (especially two orthogonal directions).

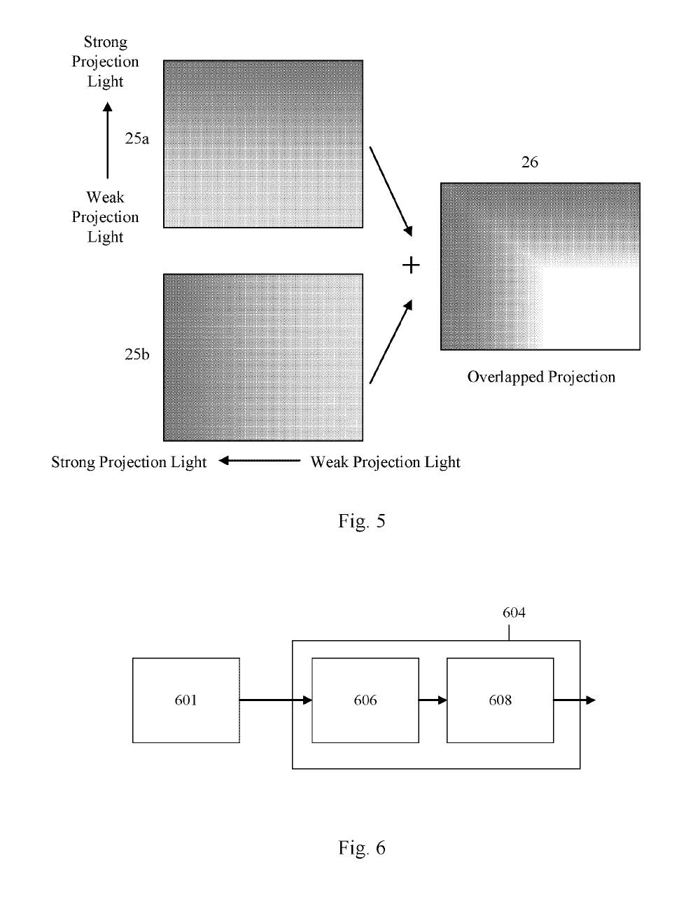

For example, the image generation device 406a may be configured so that the intensity or luminance of the radiation in the image monotonously increases (or decreases) in the first direction (for example from down to up), as indicated by 25a in FIG. 5; and the image generation device 406b may be configured so that the intensity or luminance of the radiation in the image monotonously increases (or decreases) in the second direction (for example, from the right to the left) orthogonal to the first direction, as indicated by 25b in FIG. 5. For example, this may be achieved by configuring the image generation device 406a to have a monotonously increasing (or decreasing) transmittance in the first direction (for example from down to up) and configuring the image generation device 406b to have a monotonously increasing (or decreasing) transmittance in the second direction (for example from the right to the left). The image generation devices 406a and 406b may be implemented by optical sheets, SLMs or the like. When the two projected images 25a and 25b are overlapped on the projection plane 402, a combined projection may be generated as illustrated by 26.

It is to be noted that in the example illustrated in FIG. 5, the projected image 25a and the projected image 25b have the same size, and are completely overlapped on the projection plane 402. However, the present disclosure is not limited thereto. The projected image 25a and the projected image 25b may have different sizes, and may not be completely overlapped or even are not overlapped on the projection plane 402.

According to another embodiment of the present disclosure, the image generation device 406a may be configured so that the wavelength of the radiation in the image monotonously increases (or decreases) in the first direction (for example from down to up); and the image generation device 406b may be configured so that the wavelength of the radiation in the image monotonously increases (or decreases) in the second direction (for example, from the right to the left) orthogonal to the first direction. For example, this may be implemented by configuring the irradiation sources 405a and 405b as white light sources or radiation sources covering a certain wavelength range, configuring the image generation device 406a as filters (or referred to as color filters) whose transmissive wavelengths monotonously increase (decrease) arranged sequentially from down to up and configuring the image generation device 406b as filters (or referred to as color filters) whose transmissive wavelengths monotonously increase (decrease) arranged sequentially from the right to the left.

According to another embodiment of the present disclosure, the image generation device 406a may be configured so that the chroma of the radiation in the image monotonously varies (for example, in the RGB chromatic diagram) in the first direction (for example from down to up); and the image generation device 406b may be configured so that the chroma of the irradiation in the image monotonously varies (for example, in the RGB chromatic diagram) in the second direction (for example, from the right to the left) orthogonal to the first direction. For example, this may be achieved as follows. Specifically, the irradiation sources 405a and 405b may be configured to emit mixed light including three-primary colors, i.e., Red (R), Green (G) and Blue (B). The image generation device 406a is configured with (an array of) color filters, to filter one or more components of the R, G, and B irradiation by different attenuation coefficients, so that the monotonously varying chroma is presented from down to up (i.e., the R, G, and B components are combined in different proportions). The image generation device 406b is configured with (an array of) color filters, to filter one or more components of the R, G, and B irradiation by different attenuation coefficients, so that the monotonously varying chroma is presented from the right to the left (i.e., the R, G, and B components are combined in different proportions). The image generation devices 406a and 406b may also be implemented by spatial light modulators.

In the above embodiments, the variation in the intensity (or luminance), wavelength, chroma or the like of the radiation is implemented mainly by the image generation devices 406a and 406b. However, the present disclosure is not limited thereto. For example, the irradiation sources 405a and/or 405b may comprise an array of irradiation source units, and the irradiation source units in the array may be controlled individually. Thus, the irradiation source units in the array of the irradiation source 405a and/or 405b may be controlled to emit radiation with different intensities (or luminance) or at different wavelengths respectively along the first direction (for example, from down to up) and/or the second direction (for example, from the right to the left). In addition, each irradiation source unit may comprise three-primary color (for example, RGB) sub-pixels which can be controlled individually, so as to control the irradiation source units in the array of the irradiation source 405a and/or 405b to emit radiation with different chroma respectively along the first direction (for example, from down to up) and/or the second direction (for example, from the right to the left) (for example, by adjusting the luminance proportions of the R, G, and B sub-pixels in each irradiation source unit). In this case, the image generation devices 406a and 406b may be in a form of, for example, grid, to avoid unnecessary mutual interference of the light emitted from the irradiation source units.

In the case where the projected image comprises a pattern of a monotonous variation in the feature of the radiation itself, such as intensity (or luminance), wavelength, chroma or the like, along one or more directions (especially along two orthogonal directions) as described above, the direction information may be determined according to a variation in the corresponding feature which is detected at the same imaging pixel of the image capture module 404

For example, in a case where the intensity of the radiation varies as described above (as shown in FIG. 5), the direction information may be determined by detecting a variation in the light intensity at a point (or multiple points). Therefore, the imaging planes 410a and/or 410b may comprise a simple photoelectric detector, such as a (single) photodiode, without including an array of imaging pixels (for example, an array of CODs).

For a further example, in a case where the wavelength of the radiation varies as described above, the direction information may be determined by detecting a variation in the wavelength of the radiation at a point (or multiple points). Therefore, the imaging planes 410a and/or 410b may comprise a spectral measurement device.

For a still further example, in a case where the chroma of the radiation varies as described above, the direction information may be determined by detecting a variation in the chroma of the radiation at a point (or multiple points). For example, the imaging planes 410a and/or 410b may detect the chroma according to the three-primary-color principle. Therefore, the imaging planes 410a and/or 410b may comprise three photoelectric detection devices (such as photodiodes) corresponding to the three primary colors, without including an array of imaging pixels (for example, an array of CODs).

According to some embodiments of the present disclosure, respective projected images from the projection sub-modules 401a and 401b are separable (even in a case where they are partly or completely overlapped in the space). For example, the projected images may be separated optically or electrically. Accordingly, the image capture module 404 may comprise an image separation device (not shown). For example, the projection sub-modules 401a and 401b may perform projection using radiation (such as visible light or various rays or the like) in different polarization states (for example, horizontal polarization and vertical polarization). In this case, the image separation device may comprise a polarization separator (or referred to as polarization filter), to separate the two projected images. Alternatively, the projection sub-modules 401a and 401b may perform projection using radiation at different wavelengths. In this case, the image separation device may comprise a wavelength separator (or referred to as spectral filter), to separate the two projected images. Alternatively, the projection sub-modules 401a and 401b may perform projection using radiation whose intensity (or luminance) is modulated at different frequencies. In this case, the image separation device may comprise a demodulator at a corresponding frequency to separate the two projected images. The frequency modulation and demodulation may be implemented electrically. Alternatively, the projection sub-modules 401a and 401b may perform projection in a time division manner. In this case, the image separation device may detect different projected images in a corresponding time division manner. The time division modulation and demodulation may also be implemented electrically.

Thus, the image capture sub-module 404a may capture the projected image 408a (or a part thereof) from the projection sub-module 401a, and the image capture sub-module 404b may capture the projected image 408b (or a part thereof) from the projection sub-module 401b. The projection module 401 (including the projection sub-modules 401a and 401b) may vary the projection in any direction. Accordingly, the image capture module 404 (including the image capture sub-modules 404b and 404b) acquires the captured image which varies along a corresponding direction. Thereby, the direction information determination module (not shown) may acquire the direction information about the movement of the projection module 401 according to the variation in the captured image which is acquired before and after the projection module 401 is moved.

According to some embodiments of the present disclosure, in addition to determining the direction information directly using the image variation captured by the image capture module 404, the direction information may also be determined in other manners.

For example, in a case where the intensity of the radiation varies as described above (as shown in FIG. 5), the input device may comprise a feedback control device (not shown) between the image capture module 404 and the projection module 401. Thus, when the projection direction varies for example, the luminance of the captured image varies. This variation information is used to adjust the projected light (for example, by adjusting the luminance of the irradiation of the irradiation source, or by adjusting the transmission state of a spatial light modulator in a case where the image generation device comprises the spatial light modulator), so that the luminance of the captured image substantially recovers to the luminance before the variation. An adjusted amount of the luminance can indicate the direction information about the movement. In this case, there may be a communication interface between the image capture module 404 (or the direction information determination module) and the projection module 401 for exchange of related information.

In addition, in a case where the chroma of the radiation varies as described above, when the projection direction varies, the chroma of the captured image varies. This variation information may be used by the feedback control device to adjust the projected light (for example, by adjusting the chroma of the irradiation from the irradiation source units in the array of irradiation source; or by adjusting the transmission states of a spatial light modulator with respect to the respective primary colors in a case where the image generation device comprises the spatial light modulator), so that the chroma of the captured image substantially recovers to the chroma before the variation. An adjusted amount of the chroma may indicate the direction information about the movement.

In this way, it is possible to effectively avoid the influences of external noise light on the detection result.

It is to be noted that although examples including two projection sub-modules and two image capture sub-modules are described in the above embodiments, the present disclosure is not limited thereto. For example, more projection sub-modules may be included to provide information along more directions, or may be used to provide other useful information such as synchronization information, so as to enhance the stability and reliability of the system. Accordingly, more image capture sub-modules may also be included. On the other hand, fewer projection sub-modules and/or image capture sub-modules may be used. For example, only one projection sub-module may be used, and the projection sub-module may operate in a time division or space division manner, to project different images. Similarly, only one image capture sub-module may be used, and the image capture sub-module may operate in a time division or space division manner, to detect different images.

Although two embodiments are described above respectively, it does not mean that beneficial measures in the two embodiments cannot be used in combination to advantage.

The present disclosure is described above with reference to the embodiments thereof. However, these embodiments are merely for the purpose of illustration, and are not intended to limit the scope of the present disclosure. The scope of the present disclosure is defined by the appended claims and equivalents thereof. Those skilled in the art can make various substitutions and amendments without departing from the scope of the present disclosure, and these substitutions and amendments should fall into the scope of the present invention.

1-29. (canceled)

30. An input device, comprising:
a projection module configured to project an image, wherein the projection module is configured to be movable to cause a variation in the projected image, which indicates direction information about the movement to control movement of a controlled target.

31. The input device according to claim 30, further comprising:
an image capture module configured to capture at least a part of the projected image, wherein the image capture module is configured to be fixed so that when the projection module is moved, there is a variation in the captured image which indicates the direction information.

32. The input device according to claim 30, further comprising:
a direction information determination module configured to determine the direction information according to the variation.

33. The input device according to claim 31, wherein the image capture module comprises an array of imaging pixels or a number of discrete imaging pixel points.

34. The input device according to claim 30, wherein the image comprises at least one of: an array of straight lines which intersect in orthogonal directions, a two-dimensional lattice, an array of unit patterns, or other regular or irregular patterns.

35. The input device according to claim 30, wherein the projection module is configured to project two images.

36. The input device according to claim 35, further comprising:
an image capture module configured to capture at least a part of each of the two projected images, respectively.

37. The input device according to claim 36, wherein at least one of the following is configured for the projection module and the image capture module:
the projection module is configured to project the two images with radiation in different polarization states, and the image capture module comprises a polarization separator to separate the projected images;
the projection module is configured to project the two images with radiation at different wavelengths, and the image capture module comprises a wavelength separator to separate the projected images;
the projection module is configured to project the two images with radiation whose intensity is modulated at different frequencies, and the image capture module comprises demodulators at corresponding frequencies to separate the projected images; or
the projection module is configured to project the two images in a time division manner, and the image capture module is configured to separate the projected images in a corresponding time division manner.

38. The input device according to claim 35, wherein
one of the two images projected by the projection module is configured so that radiation thereof has a luminance monotonously increasing along a first direction, and the other of the two images is configured so that radiation thereof has a luminance monotonously increasing along a second direction orthogonal to the first direction; or
one of the two images projected by the projection module is configured so that radiation thereof has a chroma monotonously varying along a first direction, and the other of the two images is configured so that radiation thereof has a chroma monotonously varying along a second direction orthogonal to the first direction.

39. The input device according to claim 35, wherein one of the two images projected by the projection module is configured so that radiation thereof has a wavelength monotonously increasing along a first direction, and the other of the two images is configured so that radiation thereof has a wavelength monotonously increasing along a second direction orthogonal to the first direction.

40. The input device according to claim 38, further comprising:
a feedback control device configured to adjust the luminance of the images projected by the projection module when the projection module is moved, so that the luminance of the captured images remains substantially unvaried before and after the movement, wherein an adjusted amount of the luminance indicates the direction information; or
a feedback control device configured to adjust the chroma of the images projected by the projection module when the projection module is moved, so that the chroma of the captured images remains substantially unvaried before and after the movement, wherein an adjusted amount of the chroma indicates the direction information.

41. An input method, comprising:
projecting, by a projection module, an image;
moving the projection module to cause a variation in the projected image; and
determining direction information about the movement according to the variation to control movement of a controlled target.

42. The method according to claim 41, further comprising:
capturing, by a capture module, at least a part of the projected image,
wherein determining direction information comprises determining the direction information according to a variation in the captured image.

43. The method according to claim 41, wherein projecting an image comprises projecting two images.

44. The method according to claim 43, further comprising:
capturing, by the capture module, at least a part of each of the two projected images, respectively.

45. The method according to claim 44, wherein at least one of the following is implemented for the projecting and the capturing:
the projecting comprises projecting the two images with radiation in different polarization states,
and the capturing comprises separating, by a polarization separator, the projected images;
the projecting comprises projecting the two images with radiation at different wavelengths, and the capturing comprises separating, by a wavelength separator, the projected images;
the projecting comprises projecting the two images with radiation whose intensity is modulated at different frequencies, and the capturing comprises separating, by demodulators at corresponding frequencies, the projected images; or
the projecting comprises projecting the two images in a time division manner, and the capturing comprises separating the projected images in a corresponding time division manner.

46. The method according to claim 44, wherein
one of the two projected images is configured so that radiation thereof has a luminance monotonously increasing along a first direction, and the other of the two projected images is configured so that radiation thereof has luminance monotonously increasing along a second direction orthogonal to the first direction; or
one of the two projected images is configured so that radiation thereof has a chroma monotonously varying along a first direction, and the other of the two projected images is configured so that radiation thereof has a chroma monotonously varying along a second direction orthogonal to the first direction.

47. The method according to claim 46, further comprising:
adjusting the luminance of the images projected by the projection module when the projection module is moved, so that the luminance of the captured images remains substantially unvaried before and after the movement, wherein an adjusted amount of the luminance indicates the direction information; or
adjusting the chroma of the images projected by the projection module when the projection module is moved, so that the chroma of the captured images remains substantially unvaried before and after the movement, wherein an adjusted amount of the chroma indicates the direction information.

48. The method according to claim 44, wherein
one of the two projected images is configured so that radiation thereof has a wavelength monotonously increasing along a first direction, and the other of the two projected images is configured so that radiation thereof has a wavelength monotonously increasing along a second direction orthogonal to the first direction.
